(19) United States
(12) Patent Application Publication
(10) Pub. No.: US 2003/0179258 A1
(43) Pub. Date: Sep. 25, 2003

(54) Methods and apparatus for reducing or minimizing satellite defects in fluid ejector systems

(75) Inventors: Eduardo M. Freire, Webster, NY (US); Dale R. Ims, Webster, NY (US); Mehmet Z. Sengun, Framingham, MA (US); John R. Andrews, Fairport, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/063,105

(22) Filed: Mar. 21, 2002

(51) Int. Cl. B41J 2/015

(52) U.S. Cl. 347/20

(57) ABSTRACT

A fluid ejector system including at least one fluid ejection ejector for ejecting a main drop of a fluid. Each main drop of fluid has satellites that are formed upon ejection. An aperture plate having at least one channel is provided to alter the flight path of the satellites while allowing the main drop to pass through.

### BACKGROUND OF THE INVENTION

1. Field of Invention

This invention relates to methods and apparatus for reducing or minimizing satellite defects in fluid ejector systems. In particular, the invention relates to methods and apparatus for reducing or minimizing satellite defects in fluid ejector systems by, for example, providing an aperture plate to direct fluid ejected from fluid ejector ejectors.

2. Description of Related Art

Fluid ejector systems, such as drop-on-demand liquid ink printers, utilize various methods to eject fluids, including but not limited to piezoelectric, acoustic, phase change, wax-based and thermal systems. These systems include at least one fluid ejector from which droplets of fluid are ejected towards a recording medium, such as a sheet. A plurality of channels are defined within the fluid ejector. The fluid is disposed in the plurality of channels. Power pulses can be used to cause the droplets of fluid to be expelled as required from orifices or ejectors that are defined at the end of each of the plurality of channels. A supply container supplies fluid to the plurality of channels.

In a thermal fluid ejection system, the power pulse can be produced by heater transducers or resistors. A heater transducer or resister is typically provided for each of the channels. Each heater transducer or resistor is typically individually addressable to heat and vaporize fluid in one of the channels.

As voltage is applied across a selected heater transducer or resistor, a vapor bubble grows in the associated channel and provides an impulse to the slug of fluid in the channel in front of the expanding vapor bubble. With an outward velocity imparted to the fluid, it emerges from the front surface of the ejector structure as a jet of liquid. The jet of fluid continues to emerge from the drop ejector channel as the vapor bubble expands even though the pressure within the bubble quickly becomes negative. As the vapor bubble begins to collapse, the slug of fluid in the channel in front of the now-collapsing bubble is pulled inward. This slowing and retraction of the fluid in the channel between the heater region and the ejection-end of the channel causes the contiguous portion of the liquid jet outside the drop ejector channel to be similarly slowed. Inertial and surface tension forces cause the rear of the ejected jet of liquid to stretch to a thin ligament and ultimately sever. The ejected droplet of fluid has an elongated-teardrop shape, with the “tail” of the droplet subsequently separating from the head, and forming one to several small, satellite droplets. This dynamic train of droplets travels from the exit face of the drop ejector to the recording medium. When the liquid droplets contact the recording medium, they form a dot or spot of fluid on the recording medium. The channel is then refilled by capillary action, which, in turn, draws fluid from the supply container.

A fluid ejector can include one or more thermal fluid ejector dies having a heater portion and a channel portion. The channel portion typically includes an array of fluid channels that bring fluid into contact with the resistive heaters, which are correspondingly arranged on the heater portion. In addition, the heater portion may also have integrated addressing electronics and driver transistors. Since the array of channels in a single die assembly is typically not large enough to cover the length of the recording medium, the fluid ejector can either be scanned across the recording medium which is advanced between scans, or multiple die assemblies can be disposed adjacent to each other to produce a full-width fluid ejector.

Thermal fluid ejector ejectors typically produce spots or dots of a single size. Further, high quality fluid ejection is achieved by ejecting very small fluid droplets, which requires that the fluid channels and corresponding heaters be very small, such as, for example, in the order of 400-600 or more channels per inch.

Fluid ejectors can be utilized in many types of equipment. For example, fluid ejectors can be used in ink jet printheads that are incorporated into various types of printers, such as, for example, carriage-type printers, partial width array-type printers, and page-width type printers.

Carriage-type printers typically have a relatively small printhead containing the ink channels and ejectors. The printhead can be sealingly attached to a disposable ink supply cartridge. The combined printhead and cartridge assembly can be attached to a carriage that is reciprocated to print one swath of information at a time, on a stationary recording medium, such as paper or a transparency, where each swath of information is equal to the length of a column of ejectors.

After the swath is printed, the recording medium is stepped a distance that is at most equal to the height of the printed swath so that the next printed swath is contiguous or overlaps with the previously printed swath. This procedure is repeated until the entire image is printed.

In contrast, page-width type printers typically include a stationary printhead having a length sufficient to print across the width or length of the recording medium. The recording medium is continually moved past a page-width printhead in a direction substantially normal to the printhead length and at a constant or varying speed during the printing process. A page width fluid ejector printer is described, for instance, in U.S. Pat. No. 5,192,959, which is incorporated herein by reference in its entirety.

Fluid ejection systems typically eject fluid drops based on information received from an information output device, such as a personal computer. Typically, the received information is in the form of a raster, such as, for example, a full page bitmap or in the form of an image written in a page description language. The raster includes a series of scan lines that include bits representing individual information elements. Each scan line contains information sufficient to eject a single line of fluid droplets across the receiving medium in a linear fashion. For example, fluid ejecting printers can print bitmap information as received or can print an image written in the page description language once it is converted to a bitmap of pixel information.

### SUMMARY OF THE INVENTION

With respect to ink jet printers, it is likely that not all of the ink ejected from a channel of the drop ejector during a single firing cycle will impact the recording media to form a single, circular spot. In particular, small droplets or satellites from the initially-elongated tail of the droplet typically will not fall on top of the main drop. This is due to the fact that the satellite drops move at lower speeds than the main drops. This fact by itself makes the satellite drop fall, depending on the printing direction, to the left or right side of the spot on the recording media defined by the impact of the main drop. Further, because the satellite drops are frequently misdirected with respect to the main drop, the distance (if any) between the impact locations of the satellite drops and the main drop also depends on the printing direction. In ink jet printing, the optical density of the image formed on the recording media is dependent (among other things) on the number of droplets of ink deposited per unit area on the recording media, and—especially in regions of low-to-intermediate optical densities—the surface area of the media covered by the ink spots. Ink-media interactions cause a circular or bimodal spots due to partially-overlapping or isolated impacts of the main and satellite droplets on the media to result in greater area coverage of said media as compared to circular spots. Thus, apparent differences in the optical densities of image swaths printed in the left-to-right vs right-to-left movements of the print head in a carriage-type ink jet printer may result due to different area coverages which result from differences in the relative placements of the main drops and satellites on the media when printhead motion is reversed (see FIG. 7). The resulting banding in the printed document is perceived as an image defect, and is thus undesirable. While this image defect may be eliminated by allowing printing only during right-to-left or left-to-right movement of the printhead across the media, such restrictions reduce the throughput of the printer.

Clearly one way of eliminating the banding problem described in the previous paragraph is to achieve perfect directionality of the satellite drop. If that were possible, the result would look like FIG. 8. The problem is that the breakage of the satellite drop is highly unstable almost always resulting in misdirection. A more practical way of eliminating or minimizing the banding defect has to take the satellite misdirection as a given.

This invention provides systems and methods for reducing or minimizing satellite defects, such as the banding defect, in bidirectionally-translated fluid ejector systems by, for example, providing in one exemplary embodiment an aperture plate that directs fluid ejected from fluid ejectors.

In various exemplary embodiments of the systems and methods according to this invention, an aperture plate is provided with channels that are fluidically connected to corresponding channels in a fluid ejector system.

In various exemplary embodiments of the systems and methods according to this invention, alternate channels of the aperture plate are fabricated and/or disposed such that satellites in these alternate channels are intentionally misdirected opposite to each other with respect to a main drop which has been fired by a fluid ejection. This eliminates the banding defect because the two types of jets alternate their role producing higher or lower effective dot size during the bidirectional printing depending on the printing direction—thus resulting in the same total area coverage from swath to swath (see FIG. 9).

Of course, in practice, the satellite directionality of the alternate jets may not be exactly opposite. Even under those circumstances the invention proposed here will still significantly diminish the banding defect.

It should be pointed out, also, that the two types of jets do not have to be interposed. In other words, as long as they are built with some alternating periodicity, and the period is sufficiently small that resulting bands are not visible, the invention will achieve the desired result.

In various exemplary embodiments of the systems and methods according to this invention, channels are provided which provide suitable flow paths for fluids with varying characteristics. Thus, the invention is intended to cover methods and apparatus for reducing banding defects for any type of fluid.

In various exemplary embodiments of the systems and methods according to the invention, the shape, length, width and other properties of the channels can be adjusted to match fluid properties and to conduct and/or affect satellite placement on the recording medium.

In various exemplary embodiments of the systems and methods according to this invention, the aperture plate may be any suitable size or shape to direct satellite placement on the recording medium.

In various exemplary embodiments of the systems and methods according to the invention, satellite placement on the recording medium may be controlled by creating an electric field or by any other known or later developed method to alter the flight path of a satellite of a main drop. Thus, the invention is intended to cover methods and apparatus for reducing satellite defects that do not necessarily include the use of an aperture plate. In other words, the invention is intended to cover any method and apparatus that reduces image defects due to satellite effects with bidirectional printing using existing or later developed technologies to re-direct the satellites.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a top plan view of one exemplary embodiment of an aperture plate according to this invention;

FIG. 2 is a side elevational view of one exemplary embodiment of an aperture plate according to this invention;

FIG. 3 is a top plan view of an exemplary embodiment of an aperture plate in combination with a printhead according to this invention. Here the full line circles represent the purposely misaligned nozzles in the aperture plate and the dotted line circles the drop ejectors behind the aperture plate;

FIG. 4 is a side elevational view of one exemplary embodiment of an aperture plate in combination with a printhead according to this invention;

FIGS. 5a-5g are cross sectional views of aperture plates according to various exemplary embodiments of the invention;

FIG. 6 is a partial perspective view of an exemplary fluid ejector system that includes a printhead which is usable in combination with the apparatus and methods of the invention.

FIG. 7 shows the placement of main and satellite drops on a medium at the boundary between two swaths printed in opposite directions. In this printhead design the invention is not implemented and the banding defect is present due to the fact that all the satellites are misdirected in the same direction. In the figure, the dot labeled “1” represents the main dot and the one labeled “2,” the satellite.

FIG. 8 shows the placement of main and satellite drops on a medium at the boundary between two swaths printed in opposite directions. This is the case of a hypothetical printhead design in which there is no satellite misdirection in any of the jets.

FIG. 9 shows the placement of main and satellite drops on a medium at the boundary between two swaths printed in opposite directions. In this printhead design a version of the invention is implemented. The satellite misdirection alternates and the banding defect is eliminated.

### DETAILED DESCRIPTION OF EXEMPLARY EMBODIMENT

The following detailed description of various exemplary embodiments of the fluid ejection systems according to this invention is directed to one specific type of fluid ejection system, an ink jet printer, for the sake of clarity and familiarity. However, it should be appreciated that the principles of this invention, as outlined and/or discussed below, can be equally applied to any known or later developed fluid ejection systems, beyond the ink jet printer specifically discussed herein.

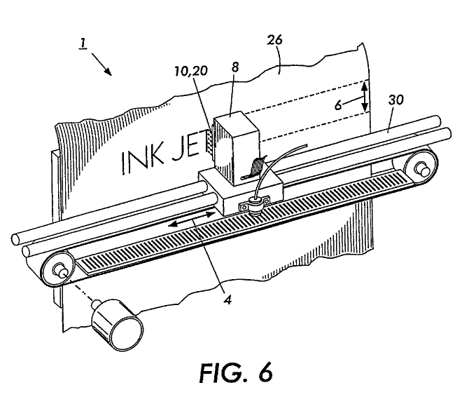

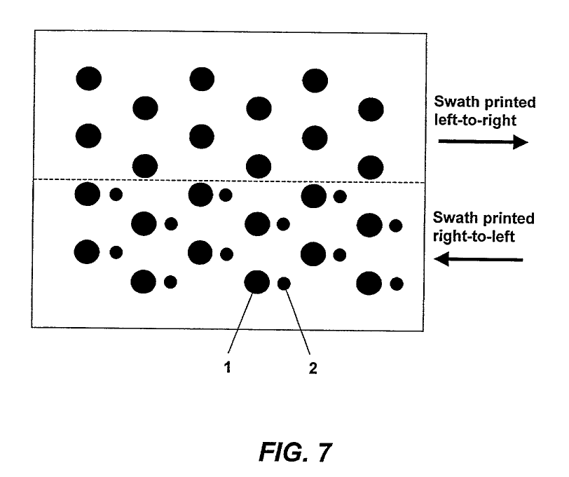

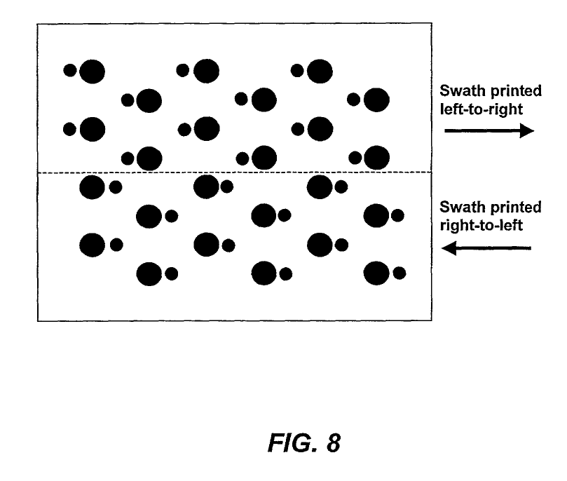

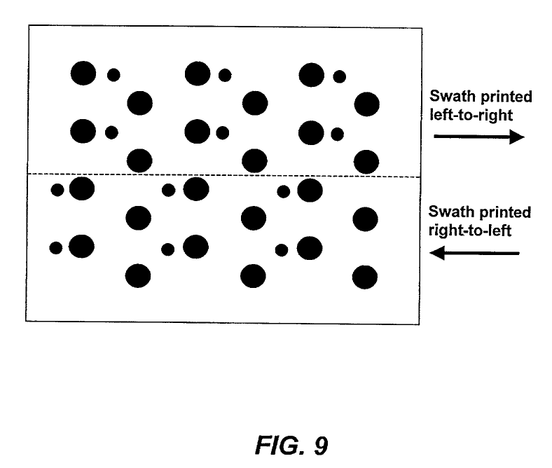

FIG. 6 is a partial perspective view of an exemplary fluid ejector system 1 that includes a printhead 8 which is usable with the apparatus and methods of the invention that reduce or minimize satellite defects printed onto a recording medium.

As shown in FIG. 6, a printhead 8 is reciprocatingly movable along guide rails 30 in the directions indicated by arrow 4. A recording medium 26 is movable in the directions indicated by arrow 6 which are substantially perpendicular to the directions of movement of the printhead 8.

In operation, the printhead 8 is moved along a linear path, the length of which is roughly defined by the sides of the recording medium 26 so that the printhead 8 is capable of printing along substantially the entire width of the recording medium 26. When the printhead 8 reaches each side of the recording medium 26, the recording medium is incrementally advanced in one of the directions of arrow 6 so that the printhead 8 is capable of printing along substantially the entire length of the recording medium 26.

The printhead includes an aperture plate 10 and an ejector structure 20 at a side adjacent to the recording medium 26. The aperture plate 10 and the ejector structure 20 can be disposed adjacent to or substantially adjacent to each other, with the aperture plate 10 being disposed facing the recording medium 26. The aperture plate 10 and the ejector structure 20 can be connected to each other by any method, such as by glue, epoxy, welding, etc., for example.

However, the aperture plate 10 and the ejector structure 20 do not have to be directly connected to each other. For example, other elements can be disposed between the aperture plate 10 and the ejector structure 20. Alternatively, the aperture plate 10 and the ejector structure 20 do not even have to be separate elements. For example, the aperture plate 10 and the ejector structure 20 can be integral and thus both formed of a single unitary element/plate.

Further, as previously discussed, the invention is intended to cover any and all methods and apparatus that reduce satellite defects on a recording medium. Thus, the invention is intended to cover apparatus and methods that do not necessarily include an aperture plate 10 and/or a ejector structure 20.

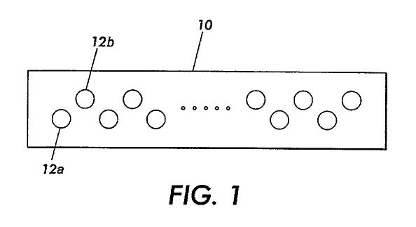

FIGS. 1-4, which are described below, more specifically show the aperture plate 10 and the ejector structure 20 according to one exemplary embodiment of the invention.

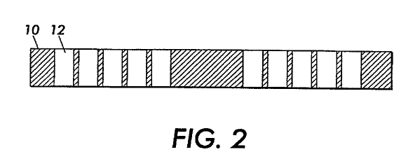

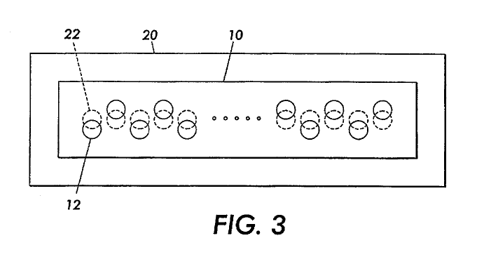

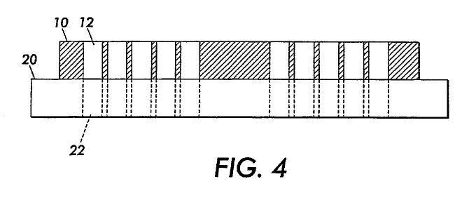

FIG. 1 and FIG. 2 depict top plan and side elevation views, respectively of the aperture plate 10 according to one exemplary embodiment of the invention. The aperture plate 10 defines channels 12 (12a & 12b in FIG. 1) which can be substantially aligned with ejectors 22 of the ejector structure 20 (shown in FIGS. 3 and 4 and discussed in more detail below) of an ink jet printer printhead 8. It should be appreciated that the aperture plate 10 may contain only one channel 12 or any suitable number of channels 12.

As depicted in FIGS. 3 and 4, the aperture plate 10 can be placed on or over the ejector structure 20. For example, the aperture plate 10 is placed at a fluid exit side of the ejector structure 20, such that the aperture plate 10 is disposed between the ejector structure 20 and the recording medium 26.

Thus, as ink is ejected through ejectors 22, which are channels defined in the ejector structure 20, and subsequently passes through channels 12 of aperture plate 10, any satellites resulting from droplet formation and separation are redirected. By redirecting the satellites, it is possible to control placement of satellites to reduce, minimize or prevent satellite defects, such as, for example, banding.

The disposition of the aperture plate 10 relative to the ejector structure 20 may be determined by any suitable alignment process based on enhanced or optimum satellite placement onto the recording medium 26. For example, the aperture plate 10 may be disposed such that the channels 12 of the aperture plate 10 are exactly or substantially aligned with the ejector 22 of the ejector structure 20. Alternatively, as shown in FIG. 3, the channels 12 of the aperture plate 10 can be substantially offset with respect to the ejectors 22 of the ejector structure 20. However, an exit side of at least one ejector 22 of the ejector structure 20 should typically functionally or structurally overlap to some extent with an entrance side of at least one channel 12 of the aperture plate 10.

In operation, ink enters an entrance side of the ejectors 22 of the ejector structure, travels through the length of the ejectors 22, and exits an exit side of the ejector 22. Upon exiting the exit side of the ejectors 22, the ink enters an entrance side of the channels 12 of the aperture plate 10, travels through the channels, and exits an exit side of the channels 12 to impact a recording medium.

We have verified experimentally that with this type of geometries the satellite drop can be steered so that the satellite will ultimately impact the recording medium at a location to reduce the banding defect.

The multiple channels 12 of the channel plate 10 may be entirely or substantially aligned in their direction of extension in a widthwise direction of the aperture plate 10 such that no channels 12 are spaced from the other channels in the direction perpendicular to their direction of extensions (hereinafter the depth direction). In this structure, all of the multiple channels 12 form a single row.

Alternatively, one or more channels 12 can be spaced from the other channels in the depth direction. For example, as shown in FIGS. 1 and 3, the channels 12 can be disposed so as to be aligned in and form two rows. In the exemplary embodiment shown in FIGS. 1 and 3, the channels 12 are disposed such that each channel is spaced from its respective adjacent channel 12 or channels 12 (depending on whether the channel is at the end of the row) in the depth direction.

In inkjet printers it is advantageous to print bi-directionally. When printing bi-directionally a satellite may fall ahead of the main drop in one print direction and behind the main drop in the other print direction. In this exemplary embodiment where the channels alternate in the depth direction to form two rows, in an ink-jet printer that prints bi-directionally, satellites in even channels 12a are misdirected in one printing direction to land on the recording medium in a predetermined relation to the main drop. Satellites in odd channels 12b are misdirected to land on the recording medium also in a predetermined relation to the main drop. When printing in the second direction, the satellites in even channels will have the same predetermined relation to the main drop as the satellites in the odd channels when printing in the first direction, and the satellites of the odd channels will have the same predetermined relation to the main drop as the satellites in the even channels when printing in the first direction. For example, in the first printing direction the satellites in the even channels are misdirected to fall on the same area as the main drop and the satellites in the odd channels are misdirected to fall behind the main drop. In the second printing direction the satellites in the even channels are misdirected to fall behind the main drop and the satellites in the odd channels are misdirected to fall on the same area as the main drop. In this way the area coverage is substantially identical enough to minimize the banding defect.

In other exemplary embodiments the relation of the satellites to the main drops may be changed so long as the area coverage in the first and second printing directions is substantially identical enough to minimize the banding defect.

In other exemplary embodiments according to the systems and methods of the invention the channels may be divided into any suitable fraction small enough to be imperceptible to the human eye. For example, instead of even and odd channels, there could be two pairs of channels that alternate in each direction. In this way, the area coverage when printing in one direction is equal to the area coverage obtained when printing in the reverse direction.

The ejectors 22 of the ejector structure 20 can similarly be spaced apart from each other in their direction of extension and the depth direction. In other words, the alternative spacing embodiments discussed above with regard to the channels 12 also apply to the ejectors 22 spacing.

The ejectors 22 of ejector structure 20 do not have to be linearly arranged. In other words, the invention also applies to two dimensional arrays of drop ejectors of the “roof-shooter” type.

The channels 12 of the aperture plate 10 may be structured to accommodate different characteristics of various different inks in a multi-color printhead. For example, the various different inks can have different ejection velocities, viscosities, etc. In order to take these different characteristics into account, the channels 12 may have different widths or lengths, for example. Alternatively, any structure of the channels 12 can be changed that compensates for the different ink characteristics with regard to satellite misdirection.

Other factors that are unrelated to the characteristics of the ink itself (such as viscosity, drying time, ejection velocity, etc.) can also affect structural features of the channels 12. For example, the distance separating the exit side of the aperture plate 10 from the recording medium may affect or constrain the shape of the channels 12 in order to achieve a reduction in satellite misdirections.

As discussed above, the aperture plate 10 and the ejector structure 20 may either be separate and distinct elements, or alternatively may be integrated. Similarly, the aperture plate 10 and the ejector structure 20 may either be separate or integral with other structures of the printhead 8. As discussed above, although the aperture plate 10 is depicted as being adjacent the ejectors 22, the aperture plate 10 can be placed in any suitable relation to the ejectors 22 such that the satellites are directed to a location that minimizes fluid ejection defects.

The aperture plate 10 may be manufactured from any suitable material, including but not limited to synthetic resin, polyimide, aluminum, etc. The aperture plate 10 may also be manufactured by any suitable method, including but not limited to casting, machining, extruding, etc.

As discussed above, the aperture plate 10 may be attached to the printhead 20 by any suitable device or method, such as adhesives, mechanical attachment, etc. A gasket or any other suitable method or device may be used to prevent fluid from leaking in a space that may be defined between the aperture plate 10 and the ejector structure 22.

The aperture plate 10 may be of any suitable thickness. The thickness of the aperture plate 10 may depend on the space available in the fluid ejector system, the fluid characteristics, the results of satellite placement, etc., for example. The dimensions of the aperture plate 10 relative to the ejector structure 22, may be of any suitable dimension and shape to reduce satellite misdirections.

As previously discussed, channels 12 of the aperture plate 10 of virtually any size and shape can be used to reduce satellite misdirections. The channels 12 can define a regular cross-section throughout their length, as shown in FIGS. 2 and 4.

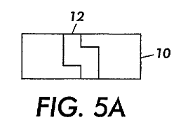

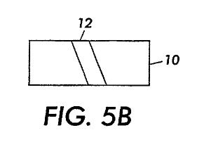

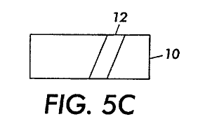

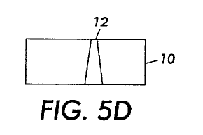

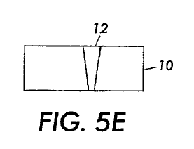

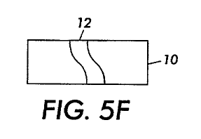

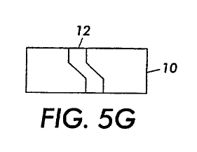

Alternatively, channels 12 defining other irregular cross-sections can also be used. For example, FIGS. 5(a)-5(g) are cross-sectional views of various alternative channel 12 designs. However, FIGS. 5(a)-5(g) are merely provided for exemplary purposes, and as discussed above, channels 12 of any shape can be used.

Further, as discussed above, the invention is intended to cover any method and apparatus to reduce banding defects due to satellite misdirections. Thus, the structural elements discussed above, such as the aperture plate 10, should not be considered a necessary feature of the invention.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A fluid ejection system for use with fluid that is formable into at least one main drop and at least one satellite, comprising:
an ejector structure that defines at least one ejector channel from which the fluid is ejected which forms at least one main drop and at least one satellite;
an aperture plate defining at least one channel through which the working fluid passes to form at least one main drop and at least one satellite, a trajectory of the at least one satellite being altered by the at least one channel.

2. The fluid ejection system of claim 1, including a printhead movable in first direction and a second direction opposite to the first direction,
the aperture plate further defining at least two channels that alter a trajectory of at least two satellites of at least two main drops so as to impact on a recording medium when the printhead is moving in the first direction; and
altering a trajectory of at least two satellites of at least two main drops so as to impact on a recording medium when the print head is moving in the second direction.

3. The fluid ejection system of claim 1, further including a printhead movable in a first direction and a second direction opposite to the first direction,
the aperture plate further defining at least one first channel that, in a first direction, alters a trajectory of a first satellite of a first main drop so as to impact a recording medium at a location having a first predefined relation to the first main drop, and at least one second channel that, in a first direction, alters a trajectory of a second satellite of a second main drop so as to impact the recording medium at a location having a second predefined relation to the second main drop, and in a second direction the at least one channel alters a trajectory of a third satellite of a third main drop so as to impact the recording medium at a location having the second predefined relation to the third main drop, and the at least one second channel alters a trajectory of a fourth satellite of a fourth main drop so as to impact the recording medium at a location having the first predefined relation to the fourth main drop.

4. The fluid ejection system of claim 2, wherein at least one satellite impacts the recording medium on the same area where the main drop impacts the recording medium.

5. The fluid ejection system of claim 2, wherein at least one satellite impacts the recording medium in an area partially or completely separated from the area whereupon the main drop impacts the recording medium in the direction the printhead is moving.

6. The fluid ejection system according to claim 1, wherein the at least one channel includes multiple channels disposed so as to form two rows in the direction of extension.

7. The fluid ejection system according to claim 6, wherein adjacent channels are spaced from each other in a direction perpendicular to the direction of extension.

8. The fluid ejection system according to claim 1, wherein the ejector structure and the aperture plate are separate elements fixed together.

9. The fluid ejection system according to claim 1, wherein the ejector structure and the aperture plate are integrally formed.

10. The fluid ejection system according to claim 1, wherein at least one ejector and the at least one channel are substantially aligned with respect to each other.

11. The fluid ejection system according to claim 1, wherein at least one ejector and the at least one channel are substantially offset with respect to each other.

12. An aperture plate, comprising:
at least one channel placed to allow at least one main drop ejected from a fluid ejection system to pass through the aperture plate, while altering the flight path of at least one satellite associated with the at least one main drop.

13. The aperture plate according to claim 12, wherein at least one channel defines a substantially uniform cross-section in its lengthwise direction.

14. The aperture plate according to claim 12, wherein at least one channel define a substantially variable cross-section in its lengthwise direction.

15. A method of controlling at least one satellite according to claim 15, the fluid ejection system including a printhead movable in the first direction and the second direction opposite to the first direction, the method further comprising:
altering a trajectory of a first satellite of a first main drop so as to impact on a recording medium when the printhead is moving in the first direction;
altering a trajectory of a second satellite of a second main drop so as to impact on the recording medium when the printhead is moving in the first direction;
altering a trajectory of a third satellite of a third main drop so as to impact an recording medium when the printhead is moving in the second direction; and
altering a trajectory of a fourth satellite of a fourth main drop so as to impact the recording medium when the printhead is moving in the second direction.

16. The method of controlling at least one satellite according to claim 15, the method further comprising altering the trajectory of the first and second satellites to provide substantially the same area coverage as the area coverage resulting from changing the trajectory of the third and fourth satellites.

17. The fluid ejection system, comprising:
means for ejecting at least one satellite; and
means for altering the trajectory of the at least one satellite.
